(19) United States
(12) Patent Application Publication
(10) Pub. No.: US 2022/0232894 A1
(43) Pub. Date: Jul. 28, 2022

(54) INDUCTOR COIL FOR AN AEROSOL PROVISION DEVICE

(71) Applicant: NICOVENTURES TRADING LIMITED, London (GB)

(72) Inventors: Luke James WARREN, London (GB); Mitchel THORSEN, Madison, WI (US)

(21) Appl. No.: 17/595,812

(22) PCT Filed: May 27, 2020
(86) PCT No.: PCT/EP2020/064654

§ 371 Date: Nov. 24, 2021

(30) Foreign Application Priority Data
May 28, 2019 (GB) 1907527.4
Nov. 8, 2019 (GB) 1916297.3

(51) Int. Cl. A24F 40/465; H05B 1/02; H05B 6/10; H05B 6/36

(52) U.S. Cl. CPC A24F 40/465; H05B 6/36; H05B 6/108; H05B 1/0244

(57) ABSTRACT

In one aspect a support member is provided. The support member is for forming an inductor coil of an aerosol provision device, and defines an axis about which a multistrand wire of the inductor coil is windable. An outer surface of the support member comprises a channel to receive the wire. In another aspect there is provided a method of forming an inductor coil for an aerosol provision device. The method comprises providing a multi-strand wire comprising a plurality of wire strands, wherein at least one of the plurality of wire strands comprises a bondable coating; winding the multi-strand wire around a support member defining an axis; activating the bondable coating such that the multi-strand wire substantially retains a shape determined by the support member; reducing a cross-sectional width of the support member in a direction perpendicular to the axis; and removing the multistrand wire from the support member.

### TECHNICAL FIELD

The present invention relates to a method of forming an inductor coil for an aerosol provision device, a support member, an aerosol provision device inductor coil manufacturing system, an inductor coil, and a system.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided a method of forming an inductor coil for an aerosol provision device, the method comprising:

providing a multi-strand wire comprising a plurality of wire strands, wherein at least one of the plurality of wire strands comprises a bondable coating;

winding the multi-strand wire around a support member such that the multi-strand wire is received in a channel formed in an outer surface of the support member;

activating the bondable coating such that the multi-strand wire substantially retains a shape determined by the channel; and

removing the multi-strand wire from the support member.

According to a second aspect of the present disclosure, there is provided a support member for forming an inductor coil of an aerosol provision device, the support member defining an axis about which a multi-strand wire of the inductor coil is windable, wherein an outer surface of the support member comprises a channel to receive the multi-strand wire.

According to a third aspect of the present disclosure, there is provided an aerosol provision device inductor coil manufacturing system, comprising:

a support member according to the second aspect; and

a drive assembly configured to rotate the support member about an axis of the support member, such that, in use, the multi-strand wire is wound on to the support member.

According to a fourth aspect of the present disclosure, there is provided an inductor coil for an aerosol provision device, the inductor coil formed according to a method comprising the method of the first aspect.

According to a fifth aspect of the present disclosure, there is provided an inductor coil for an aerosol provision device, wherein the inductor coil defines an axis and comprises a multi-strand wire that is wound around the axis, and wherein the multi-strand wire has a cross section with a greatest lateral dimension that is greater than a greatest longitudinal dimension, wherein the greatest lateral dimension is measured in a direction perpendicular to the axis, and the greatest longitudinal dimension is measured in a direction perpendicular to the greatest lateral dimension.

According to a sixth aspect of the present disclosure, there is provided an aerosol provision device comprising:

a receptacle for receiving at least part of an article comprising aerosolisable material; and

a heating assembly for heating the article when the article is arranged in the receptacle, wherein the heating assembly comprises:

at least one of the inductor coils of any of the fourth and fifth and tenth aspects for generating a varying magnetic field for penetrating a susceptor to thereby cause heating of the susceptor.

According to a seventh aspect of the present disclosure, there is provided a support member for use in forming an inductor coil of an aerosol provision device, the support member defining an axis about which a wire of the inductor coil is windable, wherein the support member is moveable between a first configuration, in which the wire is windable around the support member, and a second configuration, in which a cross sectional width of the support member perpendicular to the axis is smaller than when the support member is in the first configuration thereby to facilitate removal of the wire from the support member.

According to an eighth aspect of the present disclosure, there is provided a system comprising:

a support member according to the seventh aspect; and

a device configured to cause movement of the support member between the first and second configurations.

According to a ninth aspect of the present disclosure, there is provided a method of forming an inductor coil for an aerosol provision device, the method comprising:

providing a multi-strand wire comprising a plurality of wire strands, wherein at least one of the plurality of wire strands comprises a bondable coating;

winding the multi-strand wire around a support member defining an axis;

activating the bondable coating such that the multi-strand wire substantially retains a shape determined by the support member;

reducing a cross-sectional width of the support member in a direction perpendicular to the axis; and

removing the multi-strand wire from the support member.

According to a tenth aspect, there is provided an inductor coil for an aerosol provision device, the inductor coil formed according to a method comprising the method of the ninth aspect.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a front view of an example of an aerosol provision device;

FIG. 2 shows a front view of the aerosol provision device of FIG. 1 with an outer cover removed;

FIG. 3 shows a cross-sectional view of the aerosol provision device of FIG. 1;

FIG. 4 shows an exploded view of the aerosol provision device of FIG. 2;

FIG. 5A shows a cross-sectional view of a heating assembly within an aerosol provision device;

FIG. 5B shows a close-up view of a portion of the heating assembly of FIG. 5A;

FIG. 6 shows a perspective view of first and second inductor coils wrapped around an insulating member;

FIG. 7 shows a flow diagram of an example method of forming an inductor coil;

FIG. 8 shows a perspective view of manufacturing equipment used to form an inductor coil; and

FIGS. 9A and 9B show perspective views of an inductor coil being formed; and

FIG. 10A is a diagrammatic representation of a support member according to a first example;

FIGS. 10B and 10C are close-up views of a portion of the support member of FIG. 10A;

FIG. 11 is a diagrammatic representation of a support member according to a second example;

FIG. 12 is a diagrammatic representation of a support member according to a third example;

FIG. 13 is a diagrammatic representation of a support member according to a fourth example;

FIG. 14 is a diagrammatic representation of a support member according to a fifth example;

FIG. 15 is a diagrammatic representation of a support member according to a sixth example;

FIG. 16A is a diagrammatic representation of a support member according to a seventh example, where the support member is arranged in a first configuration;

FIG. 16B depicts the support member of FIG. 16A surrounded by a wire;

FIG. 16C is a cross-sectional view of the support member of FIG. 16A;

FIG. 16D is a cross-sectional view of the support member of FIG. 16B;

FIG. 17A depicts the support member of FIG. 16A arranged in a second configuration;

FIG. 17B depicts the support member of FIG. 17A surrounded by a wire;

FIG. 17C is a cross-sectional view of the support member of FIG. 17A;

FIG. 17D is a cross-sectional view of the support member of FIG. 17B;

FIG. 18A is an end view of the support member of FIG. 16A;

FIG. 18B is an end view of the support member of FIG. 17A;

FIG. 19A is a cross-sectional block diagram of a device inserted into a hollow cavity of an example support member;

FIG. 19B is a cross-sectional block diagram of a device partially removed from a hollow cavity of an example support member; and

FIG. 20 shows a flow diagram of a second example method of forming an inductor coil.

### DETAILED DESCRIPTION

As used herein, the term “aerosol generating material” includes materials that provide volatilised components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilise at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporise an aerosol generating material in the form of a liquid, which may or may not contain nicotine. The aerosol generating material may be in the form of or be provided as part of a rod, cartridge or cassette or the like which can be inserted into the apparatus. A heater for heating and volatilising the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

A first aspect of the present disclosure defines a method of forming an inductor coil for use in an aerosol provision device. The method starts with a multi-strand wire, such as a litz wire. A multi-strand wire is a wire comprising a plurality of wire strands and is used to carry alternating current. Multi-strand wire may be used to reduce skin effect losses in a conductor and comprises a plurality of individually insulated wires which are twisted or woven together. The result of this winding is to equalize the proportion of the overall length over which each strand is at the outside of the conductor. This has the effect of distributing alternating current equally among the wire strands, reducing the resistance in the wire. In some examples the multi-strand wire comprises several bundles of wire strands, where the wire strands in each bundle are twisted together. The bundles of wires are twisted/woven together in a similar way.

After a multi-strand wire has been provided, the method comprises winding the multi-strand wire around a support member such that the multi-strand wire is received in a channel formed around an outer surface of the support member. The support member acts as a support for forming the inductor coil. The support member may be tubular or cylindrical, for example, and the multi-strand wire can be helically wound/wrapped around the support member.

In the present disclosure, the support member has a channel which extends around the outer surface of the support member. The channel receives the multi-strand wire as it is wound around the support member. The spacing between adjacent turns in the channel can set the spacing between the adjacent turns of the formed inductor coil. The inductor coil therefore takes on the shape provided by the channel. The channel allows the shape and dimensions of the inductor coil to be better controlled during manufacture. The channel can be used to retain the multi-strand wire in place relative to the support member while the inductor coil is being formed.

The channel may be helical in some examples. The helical channel may have a constant or varying pitch along the axis of the support member. The channel may be known as a recessed guide path or a groove. The support member may also be known as a forming jig or mandrel.

At least one of the plurality of wire strands comprises a bondable coating. A bondable coating is a coating which surrounds the wire strand, and which can be activated (such as via heating), so that the wire strand within the multi-strand wire bonds to one more neighbouring strands. The bondable coating allows the multi-strand wire to be formed into the shape of an inductor coil on the support member, and after the bondable coating is activated, the inductor coil will retain its shape. The bondable coating therefore “sets” the shape of the inductor coil. In some examples, the bondable coating is the electrically insulating layer which surrounds the conductive core. However, the bondable coating and the insulation may be separate layers, and the bondable coating surrounds the insulating layer. In an example, the conductive core of the multi-strand wire comprises copper. The bondable coating may comprise enamel.

While the multi-strand wire is arranged in the channel, the method may further comprise activating the bondable coating such that the multi-strand wire substantially retains a shape determined by the channel. The multi-strand wire (now in the shape of the inductor coil) can be removed from the support member without losing its shape.

The above method can be performed to form inductor coils for use in aerosol provision devices. In some examples, the device may comprise two or more inductor coils. Each inductor coil is arranged to generate a varying magnetic field, which penetrates a susceptor. As will be discussed in more detail herein, the susceptor is an electrically conducting object, which is heatable by penetration with a varying magnetic field. An article comprising aerosol generating material can be received within the susceptor, or be arranged near to, or in contact with the susceptor. Once heated, the susceptor transfers heat to the aerosol generating material, which releases aerosol.

Winding the multi-strand wire and activating the bondable coating may comprise changing a cross-sectional shape of at least part of the multi-strand wire. Thus, as the multi-strand wire is received in the channel, the cross-sectional shape of the multi-strand wire may change. Accordingly, the channel may not only set the dimensions of the coil (such as the spacing between individual turns), but may also provide a means to control or alter the cross-sectional shape of the multi-strand wire.

The channel may have a predetermined cross-sectional shape, and the changing the cross-sectional shape may comprise imparting the predetermined cross-sectional shape to the multi-strand wire. The use of a channel provides a simple and effective way of manufacturing the multi-strand wire with a particular cross-sectional shape. The dimensions of the channel can therefore act as a mould to shape the multi-strand wire as necessary. This is particularly useful because certain cross-sectional shapes can provide different heating effects.

The combined effect of introducing the multi-strand wire into the channel and activating the bondable coating can modify the cross-section of the multi-strand wire.

In some examples, the support member defines an axis, and wherein the winding comprises winding the multi-strand wire around the axis. In some examples, the support member is elongate and the axis is a longitudinal axis. Changing the cross-sectional shape of the multi-strand wire may comprise modifying a cross-section of the multi-strand wire such that the cross-section of the multi-strand wire has a greatest longitudinal dimension that is different to a greatest lateral dimension, wherein the greatest longitudinal dimension is measured in a direction parallel to the axis, and the greatest lateral dimension is measured in a direction perpendicular to the greatest longitudinal dimension. Accordingly, the support member and channel may be used to form an inductor coil in which the multi-strand wire has a non-circular or non-square cross-section. For example, the width of the multi-strand wire may be smaller or larger than the depth. As mentioned, this can provide a desired heating effect.

In a particular example, changing the cross-sectional shape may comprise modifying a cross-section of the multi-strand wire such that the cross-section of the multi-strand wire has a greatest longitudinal dimension that is greater than a greatest lateral dimension. The multi-strand wire therefore has a cross-section in which the longitudinal extension (in a direction parallel to a magnetic axis of the inductor coil) is greater than a lateral extension (in a direction perpendicular to the magnetic axis). The multi-strand wire may therefore have a flattened or rectangular cross section where the individual wires within the multi-strand wire extend along the axis to a greater extent than in a direction perpendicular to the axis. Other shapes may also have these dimensions. It has been found that such a cross-section reduces energy losses in the induction coil.

In an alternative example, changing the cross-sectional shape may comprise modifying a cross-section of the multi-strand wire such that the cross-section of the multi-strand wire has a greatest longitudinal dimension that is smaller than a greatest lateral dimension. The multi-strand wire may therefore have a flattened or rectangular cross section where the individual wires within the multi-strand wire extend along the axis to a lesser extent than in a direction perpendicular to the axis. Such a configuration may allow the inductor coil to have more turns along its length, or may allow the heating effect to be reduced where necessary. For example, it may be useful to lessen the heating effect in a particular area along a susceptor.

Reference to a greatest longitudinal dimension means the longest longitudinal extension of the cross-section that is measurable in the direction parallel to the (longitudinal) axis. The cross-section may have an irregular shape, such that the longitudinal extension of the cross-section may vary at different points in the wire. Similarly, reference to a greatest lateral dimension means the longest lateral extension of the cross-section that is measurable in the direction perpendicular to the (longitudinal) axis. Again, the cross-section may have an irregular shape, such that the lateral extension of the cross-section may vary at various points along the axis. In some examples, the greatest longitudinal dimension may be known as a greatest first dimension and the greatest lateral dimension may be known as the greatest second dimension.

Modifying the cross-sectional shape of the multi-strand wire may comprise compressing the multi-strand wire in a direction parallel to the axis so as to increase a density of the plurality of wire strands. For example, the channel may have a width dimension that reduces with distance towards a base of the channel, and the reduction in width may cause the individual wires in multi-strand wire to become more densely compacted in the longitudinal dimension. This compression reduces the longitudinal extension of the multi-strand wire, and may mean that the lateral extension of the multi-strand wire increases.

Activating the bondable coating may comprise heating the support member such that the bondable coating is heated. For example, after the multi-strand wire has been wound around the support member, the multi-strand wire can be heated to cause the bondable coating of the wire strands to self-bond such that the inductor coil undergoes thermosetting. By heating the support member, the heat can be uniformly conducted to the multi-strand wire.

The method may comprise simultaneously heating the support member and winding the multi-strand wire around the support member. The heating is therefore performed at the same time as the winding. Heating while winding the multi-strand wire onto the support member allows the manufacture time to be reduced. In other examples, heating may occur after or before the multi-strand wire has been wound around the support member.

Heating the support member may comprise heating the support member to a temperature of between about 150° C. and 350° C., such as about 150° C. and 250° C. or between about 180° C. and 200° C. The bondable coating may therefore be activated at temperatures within this range.

In another example, the bondable coating may be activated via a solvent.

Activating the bondable coating may further comprise cooling the multi-strand wire after heating the bondable coating. This can cause the bondable coating to cool, thus setting the shape of the inductor coil. Cooling the multi-strand wire may comprise passing air over the multi-strand wire. An air gun or fan, for example, can blow air over the multi-strand wire. Using an air gun or fan can speed up the cooling process.

In one example the wire strands are Thermobond STP18 wires, commercially available from Elektrisola Inc., New Hampshire. These wires have been found to provide a good suitability for use in an aerosol provision device. For example, these wires have a relatively high bonding temperature such that the heated susceptor in the device does not cause the bondable coating to re-soften.

The method may further comprise rotating the support member about an axis of the support member, thereby causing the winding of the multi-strand wire around the support member. Thus, the support member can be turned so that the multi-strand wire is pulled onto the support member. This rotation makes it easier to manufacture the inductor coil. For example, this avoids having to move the wire around a static support member.

The method may further comprise moving the support member in a direction parallel to the axis (while simultaneously rotating the support member). This allows the multi-strand wire to be received in the helical channel. In a particular example, an end portion of the multi-strand wire is anchored at, or near, the end of the support member so that the multi-strand wire does not unravel.

According to the second aspect, there is provided a support member for forming an inductor coil of an aerosol provision device. The support member defines an axis, such as a longitudinal axis, about which a multi-strand wire of the inductor coil is windable, An outer surface of the support member comprises a channel to receive the multi-strand wire. The channel may be a helical channel, for example.

In some examples, the channel has a greatest depth dimension measured in direction perpendicular to the axis and a greatest width dimension measured in a direction perpendicular to the greatest depth dimension, and the greatest depth dimension is different to the greatest width dimension. In some examples, the greatest depth dimension is greater than the greatest width dimension. The channel may therefore be therefore deeper than it is wide. Such a channel can securely hold the multi-strand wire in place as it is being wound on to the support member. A channel that is deeper than it is wide can help avoid the multi-strand wire from accidentally exiting the channel before its shape can be fixed by activating the bondable coating. In some examples, the ratio of the greatest depth dimension to the greatest width dimension is between about 1.1 and 2 (i.e. between about 1.1:1 and about 2:1).

In some examples, the greatest depth dimension is less than the greatest width dimension. The channel may therefore be therefore wider than it is deep.

The channel may comprise a tapered mouth portion leading to a wire receiving portion. The wire receiving section is configured to receive the multi-strand wire. The wire receiving portion may have a greatest depth measured in direction perpendicular to the axis and a greatest width measured in a direction perpendicular to the greatest depth, and the greatest depth is different to the greatest width. In some examples, the greatest depth is greater than the greatest width. This allows an inductor coil to be formed which has a greatest longitudinal extension/dimension that is smaller than a greatest lateral extension/dimension.

In an alternative example, the greatest width may be greater than the greatest depth. This allows an inductor coil to be formed which has a greatest longitudinal dimension that is greater than a greatest lateral dimension.

The wire receiving portion is the part of the channel which holds or abuts the multi-strand wire after it has been fully received in the channel. The wire receiving portion is therefore located towards the base/floor of the channel. In examples where the channel imparts a predetermined shape to the multi-strand wire, the wire receiving portion is the part of the channel which imparts the predetermined shape. The tapered mouth portion defines a guide for guiding the multi-strand wire into the wire receiving portion of the channel. For example, the tapered mouth portion has a width dimension (measured parallel to the axis of the support member) that is decreasing towards the base of the channel. The tapered mouth portion therefore allows the multi-strand wire to be better aligned and received in the channel. The tapered mouth portion is arranged further away from the axis than the wire receiving portion. The tapered mouth portion may be provided by a bevelled or chamfered edge.

Reference to a greatest width dimension or greatest width means the widest part of the channel that is measurable in the direction parallel to the (longitudinal) axis. The channel may have an irregular width, such that the width of the channel may vary at different points. Similarly, reference to a greatest depth dimension or greatest depth means the deepest part of the channel that is measurable in the direction perpendicular to the (longitudinal) axis. The channel may have an irregular depth, such that the depth of the channel may vary at different points.

In a particular example, a ratio of the greatest depth to the greatest width is between about 1.1 and 2 (i.e. between about 1.1:1 and about 2:1). It has been found that a ratio within this range allows the heating effect of the inductor coil to be controlled, while ensuring that the multi-strand wire within the inductor coil remains correctly orientated. Optionally, the ratio is between about 1.1 and about 1.5. The ratio may be between about 1.1 and about 1.2.

In one example, the greatest width is between about 1.2 mm and about 1.5 mm. In one example, the greatest depth is between about 1.6 mm and about 1.7 mm. It has been found that an inductor coil which is formed in a wire receiving portion having these dimensions is particularly suitable for heating in an aerosol provision device.

In some examples the channel is a helical channel.

A surface of the tapered mouth portion may have a first surface gradient, and a surface of the wire receiving portion adjacent the tapered mouth portion may have a second surface gradient that is greater than the first surface gradient. The first and second surface gradients are defined relative to the axis. Accordingly, the tapered mouth portion has a gradient that is shallower than the gradient of the wire receiving section arranged next to the tapered mouth portion. A shallower gradient provides a smooth transition into the channel without inadvertently altering the cross-sectional shape of the multi-strand wire before it is received in the wire receiving portion. In one example, the surface of the wire receiving portion arranged adjacent the tapered mouth portion is arranged substantially vertically (i.e. orientated perpendicular to the axis). This vertical arrangement can provide a means of containing and securing the multi-strand wire within the channel.

In a particular example, the floor of the channel is substantially flat or rounded. That is, the base of the channel is flat or rounded. A flat or rounded shape can allow the multi-strand wire to be easily removed from the channel.

The channel may have a width dimension that reduces with distance towards a floor/base of the channel. The channel is therefore tapered, and has inclined surfaces, which can allow the multi-strand wire to be more uniformly constricted/compressed as it is received in the channel. The base of the channel is the part of the channel which is positioned furthest away from the outer surface of the support member.

The support member may be heat resistant to a temperature of greater than 150° C. This allows the support member to be heated to temperatures of at least 150° C. so that the bondable coating of the multi-strand wire can be activated via heating. The support member may be made from metal, for example, which is a good conductor of heat and has a high melting point. For example, the support member may comprise steel, stainless steel or aluminium. The support member may have a melting point of greater than about 600° C., or greater than about 700° C., or greater than about 800° C., or greater than about 1000° C., or greater than about 1500° C., for example.

According to a third aspect, there is provided an aerosol provision device inductor coil manufacturing system, comprising a support member as described in any of the above examples, and a drive assembly configured to rotate the support member about an axis, such as a longitudinal axis, of the support member, such that, in use, the multi-strand wire is wound on to the support member. The drive assembly causes the support member to rotate, and thereby allows the multi-strand wire to be wound onto the support member. The drive assembly may comprise a drum that is rotated.

The system may further comprise a wire feeding assembly for feeding the multi-strand wire on to the support member. In one example, the wire feeding assembly is passive so that it simply holds the multi-strand wire in place while the drive system causes the support member to rotate. The rotating support member therefore draws the wire on to the support member. A passive wire feeding assembly simplifies manufacture. In another example, the wire feeding assembly is active, and actively winds the wire on to the support member.

The drive assembly may be further configured to move the support member relative to the wire feeding assembly in a direction parallel to the axis. For example, the drive assembly may move the wire feeding assembly relative to a static support member, or the drive assembly may move the support member relative to the static wire feeding assembly. In a particular example, the drive assembly moves the drum (which is affixed to the support member) along a guide rail that is orientated parallel to the axis of the support member.

The system may further comprise a heater for heating the support member. For example, the support member may be heated such that the bondable coating of the multi-strand wire can be activated.

The system may further comprise an anchor configured to hold a portion of the multi-strand wire relative to the support member as the multi-strand wire is wound on to the support member. The anchor therefore secures the multi-strand wire and stops it from unravelling as the support member is rotated.

In one example, the support member comprises a threaded outer profile to receive the multi-strand wire. The threaded outer profile therefore forms a channel within which the multi-strand wire can be received.

According to a fourth aspect, there is provided an inductor coil for an aerosol provision device, the inductor coil being formed according to a method as described above.

According to a fifth aspect, there is provided an inductor coil for an aerosol provision device, wherein the inductor coil defines an axis and comprises a multi-strand wire that is wound around the axis, and wherein the multi-strand wire has a cross section with a greatest lateral dimension that is greater than a greatest longitudinal dimension, wherein the greatest lateral dimension is measured in a direction perpendicular to the axis, and the greatest longitudinal dimension is measured in a direction perpendicular to the greatest lateral dimension.

According to a sixth aspect, there is provided an aerosol provision device comprising a receptacle for receiving at least part of an article comprising aerosolisable material, and a heating assembly for heating the article when the article is arranged in the receptacle. The heating assembly comprises at least one of the inductor coils of the fourth or fifth or tenth aspects for generating the varying magnetic field for heating a susceptor. In some examples the heating assembly comprises a susceptor which is heatable by penetration with the varying magnetic field.

According to a seventh aspect, there is provided a support member that can be moved between two or more configurations. For example, the support member may be moveable between a first configuration and a second configuration. As will become apparent, a support member that changes configuration/shape can make it easier for the formed inductor coil to be removed from the support member. As above, the support member may define an axis (such as a longitudinal axis) about which a wire of the inductor coil is windable. In the first configuration, the wire may be wound around the support member to form the inductor coil. In the second configuration, the cross-sectional width of the support member (measured perpendicular to the axis) is smaller than when the support member is in the first configuration. Accordingly, in the second configuration, the support member has a smaller cross-sectional width. It has been found that reducing the cross-sectional width of the support member (after the inductor coil has been formed) allows the inductor coil to be removed more easily from the support member. For example, by reducing the cross-sectional width of the support member, the wire/coil can be at least partially separated/detached from the support member so that removal of the inductor coil does not damage or deform the inductor coil as it is being removed.

In the first configuration, the support member has a first cross-sectional width and in the second configuration, the support member has a second cross-sectional width, where the first cross-sectional width is greater than the second cross-sectional width.

In some examples the wire is a multistrand wire.

The cross-sectional width is measured perpendicular to the axis defined by the support member. This cross-sectional width may be measured along a second axis, where the second axis is perpendicular to the axis defined by the support member. The axis defined by the support member may be a first axis. In examples where the support member is substantially cylindrical in form, the cross-sectional width of the support member (in the first configuration) is equal to the diameter of the support member.

In any of the above examples, the wire is wound around the support member to form the inductor coil. Thus, the wire becomes the inductor coil after it has been formed on the support member.

In one example, the support member is monolithic, and formed from a single component. In other examples, however, the support member may be formed from a plurality of components/parts.

In a particular example, an outer surface of the support member comprises a channel to receive the wire. As explained above, the channel can receive the wire as it is wound around the support member. The spacing between adjacent turns in the channel can set the spacing between the adjacent turns of the formed inductor coil. In this particular example, the ability for the support member to change configuration is even more useful. The nature of the channel means that the wire extends into the support member, which makes it difficult to remove the inductor coil from the support member. For example, it would be difficult to slide the inductor coil along the length of the support member because it is at least partially located within the channel. By reducing the cross-sectional width of the support member, the inductor coil can be removed more easily. In one example, the cross-sectional width is reduced by at least twice the depth dimension of the channel to ensure that the inductor coil has adequate clearance.

The channel can have a depth measured parallel to the second axis, and a width dimension measured parallel to the first axis.

The support member may be biased towards the second configuration. Thus, the support member can “automatically” reconfigure to the arrangement in which the cross-sectional width is smallest. A device may hold the support member in the first configuration, when required.

In a particular arrangement, the support member may comprise one or more biasing mechanisms, such as one or more springs to bias the support member towards the second configuration.

An outer surface of the support member may be formed by a plurality of segments arranged circumferentially around the axis. Thus, in one example, the support member may be formed from a plurality of components. By moving one or more of these segments/components, the support member can be moved between the first and second configurations.

In an example, each segment extends along the length of the support member in a direction parallel to the longitudinal axis of the support member.

In examples where the support member is substantially cylindrical, each segment may have a curved profile, with an arc length that extends partially around the outer circumference of the support member.

The segments may abut one or more adjacent segments. Abutment provides a more continuous outer surface and may also improve heat conduction between segments.

At least one segment of the plurality of segments may be configured to move relative to an adjacent segment of the plurality of segments, as the support member moves between the first and second configurations. Thus, as mentioned, the support member can be reconfigured. In a particular example, the at least one segment may rotate/pivot relative to the adjacent segment.

In some examples, only a subset of the segments are moveable. For example, only part of the support member may change shape, yet the whole support member may still have a reduced cross-sectional width.

At least one segment of the plurality of segments may be connected to an adjacent segment of the plurality of segments via a hinge. Accordingly, there may be two segments that are joined by a hinge. A hinge provides a simple and effective method of moving adjacent segments. One or more of the hinges may be biased, such that the support member is biased towards the second configuration.

In some examples, at least one segment of the plurality of segments is not permanently connected to an adjacent segment of the plurality of segments. Thus, not all segments may be permanently connected (via a hinge, for example). This allows one end of the support member to move away from the other end as the support member is moved from the first configuration to the second configuration.

In some examples, at least one segment of the plurality of segments has a stop for limiting movement of the at least one segment relative to an adjacent segment thereby to limit the extent to which the support member is movable away from the second configuration. The “stop” ensures that as the support member moves from the second configuration back to the first configuration, the support member moves only to the first configuration, without extending beyond this. “Limit the extent to which the support member is movable away from the second configuration” may mean that the cross-sectional width does not become greater than the cross-sectional width of the support member in the first configuration. The stop can reduce the likelihood of the hinge (which connects the two segments) from bending in the opposite direction.

In a particular example, an outer surface of the at least one segment comprises a protruding portion, and an outer surface of the adjacent segment comprises a receiving portion to receive the protruding portion as the support member moves from the second configuration to the first configuration. The “stop” could thus be provided by the receiving portion, and the movement is limited by the protruding portion contacting the receiving portion. The protruding portion might be a lip or flange. The outer surface of each segment is the part furthest away from the longitudinal axis that runs along the centre of the support member.

In one example, in the second configuration, the support member is in a spiral configuration. For example, the support member may be rolled or curled in on itself as it moves from the first configuration to the second configuration. In an example where the support member comprises a plurality of segments, the segments may allow the support member to be rolled into the spiral configuration. The spiral configuration may be most evident when viewed along the longitudinal axis of the support member.

In one example, in the first configuration, the support member may define a hollow cavity to receive a device to hold the support member in the first configuration. For example, a device may be inserted into the middle of the support member which engages the support member to support it in the first configuration. Such a device may be particularly useful if the support member is biased towards the second configuration. Removal of the device can thus cause the support member to “automatically” move to the second configuration, particularly under the biasing force (when applied).

In one example, the device is an inserting member that contacts an inner surface of the support member. The inserting member can be moved in a first direction along the axis of the support member into the hollow cavity, and can be moved in a second direction along the axis, opposite to the first direction. The device/inserting member may have a tapered profile so that as the device is moved in the first direction, the narrowest section of the device is first inserted into the cavity (when the support member is in the second configuration) and as wider sections of the device are inserted, the cross-sectional width of the support member is gradually increased until the support member is in the first configuration.

According to the eighth aspect, a system is provided, where the system comprises a support member according to the seventh aspect, and a device configured to cause movement of the support member between the first and second configurations. The device may be the same device that is inserted into the hollow cavity of the support member to hold the support member in the first configuration.

As briefly mentioned, the device may be moveable along the axis to cause movement of the support member between the first and second configurations. This provides an effective way of altering the cross-sectional width of the support member with simple automation and few moving parts.

The system may be configured so that when the support member is in the first configuration, the device is located at a first position along the axis within a hollow cavity of the support member to hold the support member in the first configuration, and when the support member is in the second configuration, the device is located at a second position along the axis different to the first position. In some examples, in the second configuration, the device may still be partially located within the hollow cavity. In other examples, the device may be fully removed from the hollow cavity.

The system may comprise a biasing mechanism for biasing the support member towards the second configuration. In some examples, the biasing mechanism may be separate to the support member. In other examples, the biasing mechanism may be part of the support member.

According to a ninth aspect, a method of forming an inductor coil for an aerosol provision device is provided. The method comprises: (i) providing a multi-strand wire comprising a plurality of wire strands, wherein at least one of the plurality of wire strands comprises a bondable coating, (ii) winding the multi-strand wire around a support member defining an axis, (iii) activating the bondable coating such that the multi-strand wire substantially retains a shape determined by the support member, (iv) reducing a cross-sectional width of the support member in a direction perpendicular to the axis, and (v) removing the multi-strand wire from the support member.

In an example, winding the wire around the support member may comprise receiving the wire in a channel.

Reducing the cross-sectional width of the support member may comprise causing the support member to move between a first configuration and a second configuration, wherein, when the support member is in the second configuration, the cross sectional width of the support member perpendicular to the axis is smaller than when the support member is in the first configuration.

Reducing the cross-sectional width of the support member may comprise rolling the support member or collapsing the support member.

In one example, when the support member is in the first configuration, a device may be located at a first position along the axis within a hollow cavity of the support member to hold the support member in the first configuration. When the support member is in the second configuration, the device is located at a second position along the axis different to the first position. Thus, causing the support member to move between a first configuration and a second configuration may comprise moving the device between the first position and the second position.

As mentioned, an outer surface of the support member may be formed by a plurality of segments arranged circumferentially around the axis. Thus, reducing the cross-sectional width of the support member may comprise moving at least one segment of the plurality of segments relative to an adjacent segment of the plurality of segments.

In one example, winding comprises winding the multi-strand wire around the axis, and removing the multi-strand wire from the support member comprises moving the multi-strand wire relative to the support member in a direction parallel to the axis. The support member may be moved in a direction parallel to the axis while the inductor coil is held in place. Alternatively, the inductor coil may be moved, while the support member is fixed in place.

According to a tenth aspect, there is provided an inductor coil for an aerosol provision device, the inductor coil formed according to a method comprising the method of the ninth aspect.

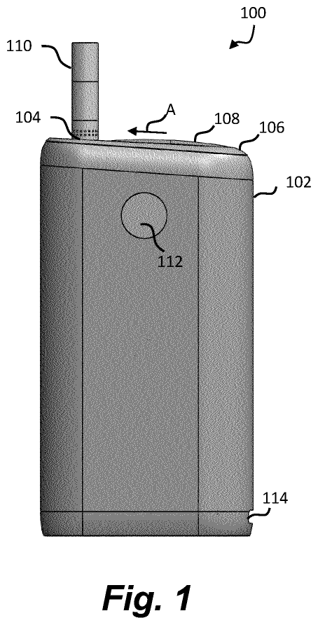

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 1, the lid 108 is shown in an open configuration, however the lid 108 may move into a closed configuration. For example, a user may cause the lid 108 to slide in the direction of arrow “A”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

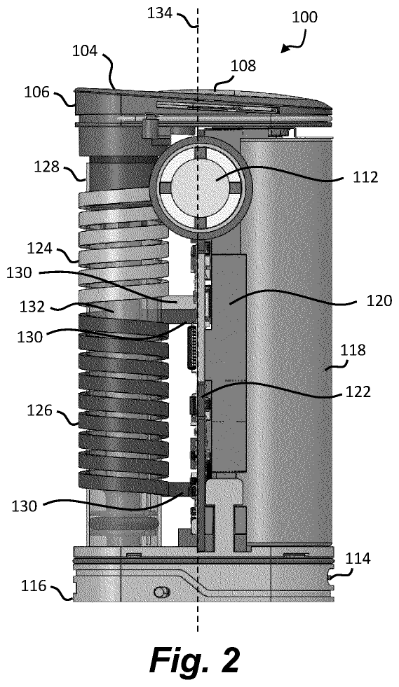

FIG. 2 depicts the device 100 of FIG. 1 with the outer cover 102 removed and without an article 110 present. The device 100 defines a longitudinal axis 134.

As shown in FIG. 2, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. In this example, the lid 108 also defines a portion of a top surface of the device 100.

The end of the device 100 closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from a multi-strand wire, such as a litz wire/cable which is wound in a generally helical fashion to provide the inductor coils 124, 126. Litz wire comprises a plurality of wire strands which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections.

The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction parallel to the longitudinal axis 134 of the device 100. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 2, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

The susceptor 132 of this example is hollow and therefore defines a receptacle within which aerosol generating material is received. For example, the article 110 can be inserted into the susceptor 132. In this example the susceptor 120 is tubular, with a circular cross section.

The device 100 of FIG. 2 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 2, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

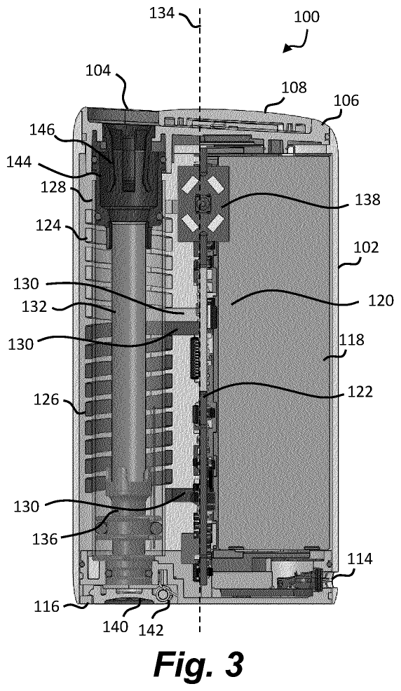

FIG. 3 shows a side view of device 100 in partial cross-section. The outer cover 102 is present in this example.

The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

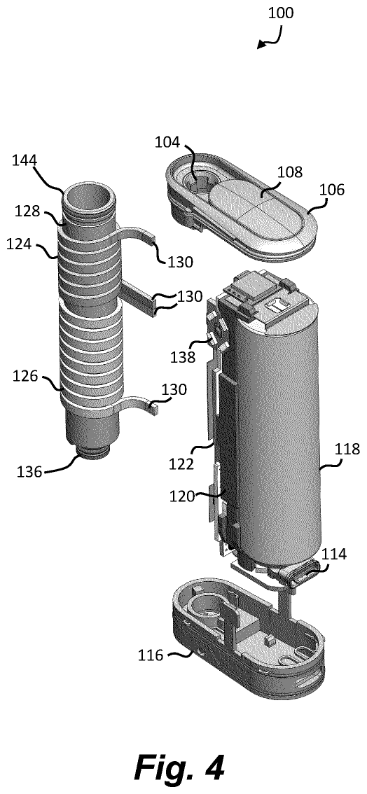

FIG. 4 is an exploded view of the device 100 of FIG. 1, with the outer cover 102 omitted.

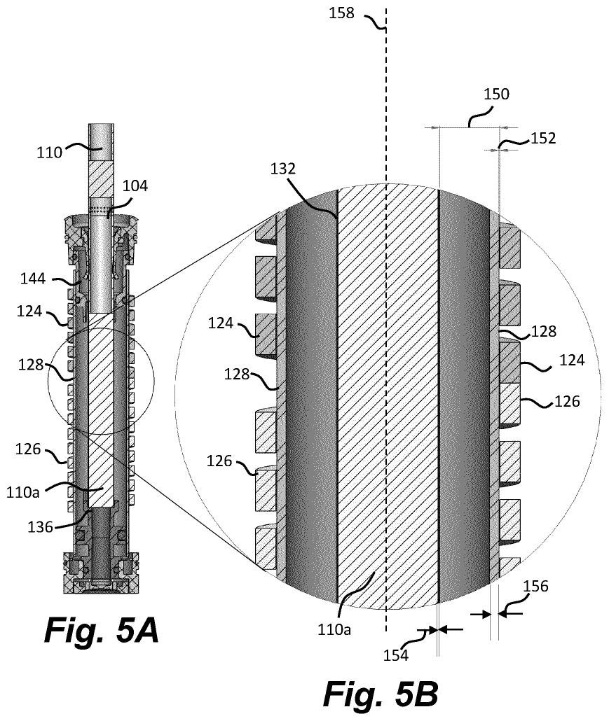

FIG. 5A depicts a cross section of a portion of the device 100 of FIG. 1. FIG. 5B depicts a close-up of a region of FIG. 5A. FIGS. 5A and 5B show the article 110 received within the susceptor 132, where the article 110 is dimensioned so that the outer surface of the article 110 abuts the inner surface of the susceptor 132. The article 110 of this example comprises aerosol generating material 110a. The aerosol generating material 110a is positioned within the susceptor 132. The article 110 may also comprise other components such as a filter, wrapping materials and/or a cooling structure.

FIG. 5B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3 mm to 3.5 mm, or about 3.25 mm.

FIG. 5B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

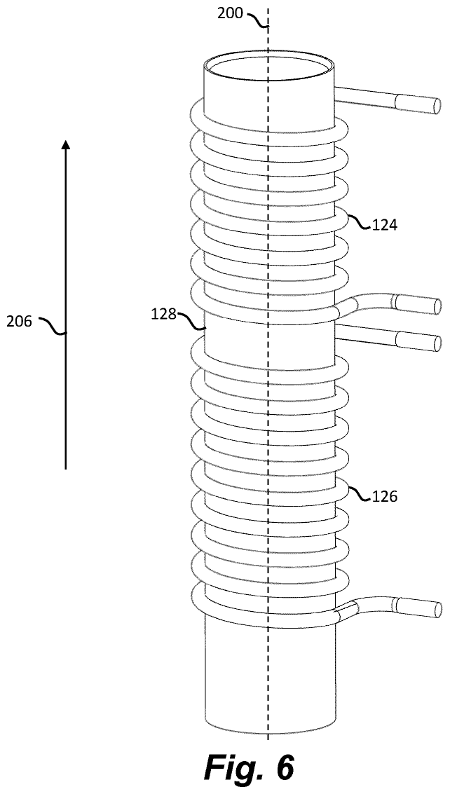

FIG. 6 depicts part of the heating assembly of the device 100. As briefly mentioned above, the heating assembly comprises a first inductor coil 124 and a second inductor coil 126 arranged adjacent to each other, in the direction along an axis 200. The inductor coils 124, 126 extend around the insulating member 128. The susceptor 132 is arranged within the tubular insulating member 128. In this example, the wires forming the first and second inductor coils 124, 126 have a circular or elliptical cross section, however they may have a different shape cross section such as a rectangular, square, “L”, “T” or triangular cross section.

The axis 200 may be defined by one, or both, of the inductor coils 124, 126. For example, the axis 200 may be a longitudinal axis of any one of the inductor coils 124, 126. The axis 200 is parallel to the longitudinal axis 134 of the device 100, and is parallel to the longitudinal axis 158 of the susceptor. Each inductor coil 124, 126 therefore extends around the axis 200.

Each inductor coil 124, 126 is formed from a multi-strand wire, such as a litz wire, which comprises a plurality of wire strands. For example, there may be between about 50 and about 150 wire strands in each multi-strand wire. In the present example, there are about 115 wire strands in each multi-strand wire.

Each of the individual wire strands has a diameter. For example, the diameter may be between about 0.05 mm and about 0.2 mm. In some examples, the diameter is between 34 AWG (0.16 mm) and 40 AWG (0.0799 mm), where AWG is the American Wire Gauge. In this example, each of the wire strands have a diameter of 38 AWG (0.101 mm).

In an example where the multi-strand wire has a circular cross-section, the multi-strand wire may have a diameter of between about 1 mm and about 2 mm. In this example, the multi-strand wire has a diameter of between about 1.3 mm and about 1.5 mm, such as about 1.4 mm.

As shown in FIG. 6, the multi-strand wire of the first inductor coil 124 is wrapped around the axis 202 about 6.75 times, and the multi-strand wire of the second inductor coil 126 is wrapped around the axis 202 about 8.75 times. The multi-strand wires do not form a whole number of turns because some ends of the multi-strand wire are bent away from the surface of the insulating member 128 before a full turn is completed. In other examples, there may be different number of turns. For example, each multi-strand wire may be wrapped around the axis 202 between about 4 to 15 times.

FIG. 6 shows gaps between successive windings/turns. These gaps may be between about 0.5 mm and about 2 mm, for example.

In some examples, each inductor coil 124, 126 has the same pitch, where the pitch is the length of the inductor coil (measured along the axis 200 of the inductor coil or along the longitudinal axis 158 of the susceptor) over one complete winding. In other examples each inductor coil 124, 126 has a different pitch.

In one example the inner diameter of the first and second inductor coils 124, 126 is about 12 mm in length, and the outer diameter is about 14.3 mm in length. In another example, the inner diameter of the first and second inductor coils 124, 126 may be between about 8 mm to about 15 mm and the outer diameter may be between about 10 mm to about 17 mm.

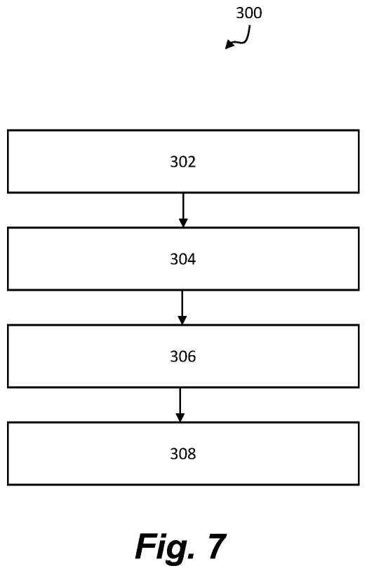

FIG. 7 depicts a flow diagram of a method 300 for forming an aerosol provision device inductor coil. Such a method can be used to form one, or both, of the inductor coils 124, 126 described in relation to FIGS. 2-6.

The method comprises, in block 302, providing a multi-strand wire comprising a plurality of wire strands, wherein at least one of the plurality of wire strands comprises a bondable coating. For example, a multi-strand wire with parameters described above may be provided. As mentioned above, a bondable coating is a coating which surrounds the wire strand, and can be activated (such as via heating), so that the strands within the multi-strand wire bond to one more neighbouring strands. The bondable coating allows the multi-strand wire to be formed into the shape of an inductor coil on a support member, and after the bondable coating is activated, the multi-strand wire will retain its shape. The bondable coating therefore “sets” the shape of the inductor coil.

The method further comprises, in block 304, winding the multi-strand wire around a support member. For example, the multi-strand wire may be wound around the support member in a helical fashion.

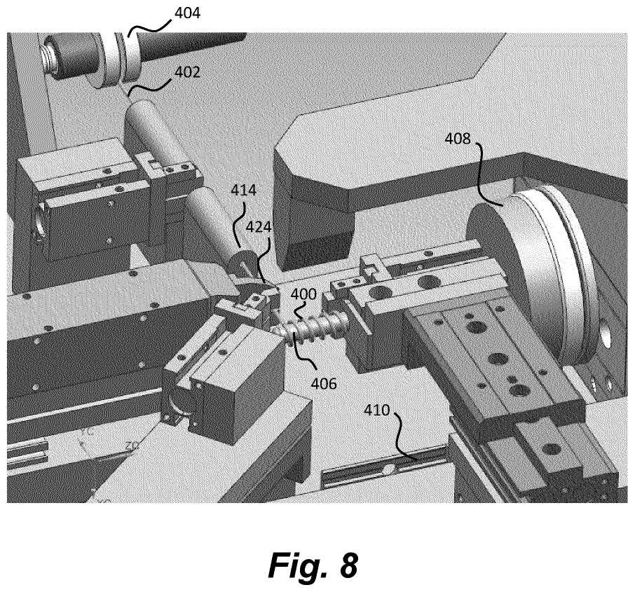

FIG. 8 depicts an example system used to form an inductor coil 400 from multi-strand wire. As shown, a multi-strand wire 402 may be initially wound around a bobbin 404 before being unraveled and wound around a support member 406. In this example, a drum 408 is rotated and moved parallel to a guide rail 410 which causes the multi-strand wire to be wound along the length of the support member 406. The drum 408 and guide rail 410 form part of a drive assembly which together wind the multi-strand wire 402 onto the support member 406.

In a particular example, the support member 406 has a channel formed in its outer surface. Thus, as the multi-strand wire 402 is wound onto the support member 406, the multi-strand wire 402 may be received in the channel. The channel provides a means to better control the shape and dimensions of the multi-strand wire 402 which forms the inductor coil 400. The channel may helically extend around the support member 406.

In some examples, the channel has a particular cross-sectional shape which is imparted to the multi-strand wire 402. The channel may therefore act as a “mould” such that the multi-strand wire 402 takes on the shape of the channel.

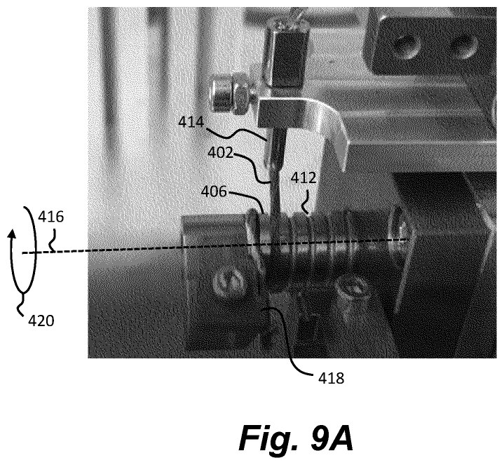

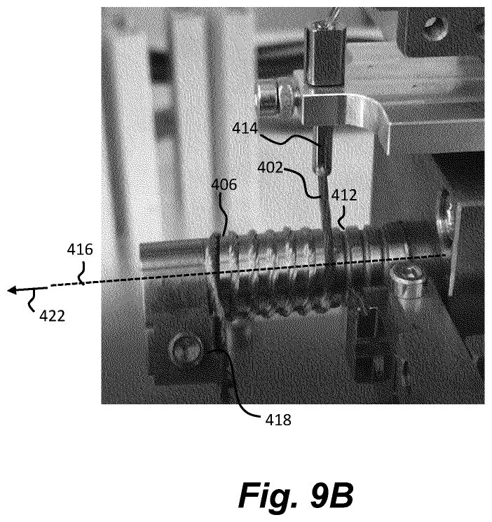

FIG. 9A depicts an alternative view of the multi-strand wire 402 being wound around the support member 406. At this moment in time, the inductor coil 400 is only partially formed, and the multi-strand wire 402 is still being wound onto the support member 406. A channel 412 can be seen extending around the outer surface of the support member 406. As the multi-strand wire 402 is wound around the support member 406, it falls into the channel 412. The channel therefore provides a means of accurately controlling the spacing between adjacent turns in the inductor coil 400.

FIGS. 8 and 9A also show a wire feeding assembly 414 which allows or controls the feeding of the multi-strand wire 402 onto the support member 406. In some examples, the wire feeding assembly 414 is passive, as shown in FIGS. 8 and 9A. For example, as mentioned, the system may comprise a drive assembly configured to cause the support member 406 to rotate around a longitudinal axis 416 defined by the support member 406. The system may also comprise an anchor 418 which holds an end portion of the multi-strand wire 402 in place. As the drive assembly rotates the support member 406 in the direction shown by arrow 420, and moves the support member 406 in a direction parallel to the longitudinal axis 416, the multi-strand wire 402 is drawn through the passive wire feeding assembly 414 and onto the support member 406.

In other examples, the wire feeding assembly 414 is active, and actively winds the multi-strand wire onto the support member 406. For example, the wire feeding assembly 414 may spin around the support member 406 while the wire is wound onto the support member 406.

FIG. 9B shows the system of FIG. 9A at a later time. At this moment in time, the inductor coil 400 is still only partially formed, but the multi-strand wire 402 has been wound around the support member 406 a greater number of times. The drive assembly has caused the support member 406 to rotate, and has moved the support member 406 in a direction 422 that is parallel to the longitudinal axis 416, while the wire feeding assembly 414 remains stationary. In alternative example, the drive assembly may move the wire feeding assembly 414 in a direction parallel to the longitudinal axis 416, while the longitudinal displacement of the support member 406 remains stationary. In either case, the drive assembly moves the support member 406 relative to the wire feeding assembly 414 to cause the multi-strand wire 402 to be wound onto the support member 406. The multi-strand wire 402 continues to be wound onto the support member 406 until the inductor coil 400 has a desired length. The multi-strand wire 402 may be cut to size using a cutting tool 424 (shown in FIG. 8).

As the multi-strand wire 402 is being wound around the support member 406, the method 300 further comprises, in block 306, activating the bondable coating such that the multi-strand wire substantially retains a shape provided by the channel. Alternatively, block 306 may occur after the multi-strand wire 402 has been fully wound around the support member 406. In the present example the multi-strand wire has an enamel bondable coating, and is activated via heating. Accordingly, while the multi-strand wire 402 remains on the support member 406 and in the channel 412, heat is applied to the multi-strand wire 402. For example, the support member 406 may be heated by a heater (not shown) which in turn causes the multi-strand wire 402 to be heated. In one example, the multi-strand wire 402 is heated to an activation temperature of about 190° C. which causes the viscosity of the bondable coating to become lower. After a predetermined period of time, the application of heat is stopped, and the bondable coating begins to cool. In some examples the cooling process can be accelerated by the application of cool air. For example, an air gun or fan may cause cooled/ambient air to flow across the multi-strand wire 402. As the temperature of the bondable coating lowers, the viscosity of the bondable coating becomes higher again. This causes the individual wire strands within the multi-strand wire bond to each other.

In an alternative example, heated air is moved over the multi-strand wire 402. For example, air is heated to an activation temperature suitable to cause the bondable coating to activate, and is moved across the inductor coil 400 via a fan or air gun.

Preferably, in either example, the heat is applied to the multi-strand wire 402 at the same time the multi-strand wire 402 is wound around the support member 406.

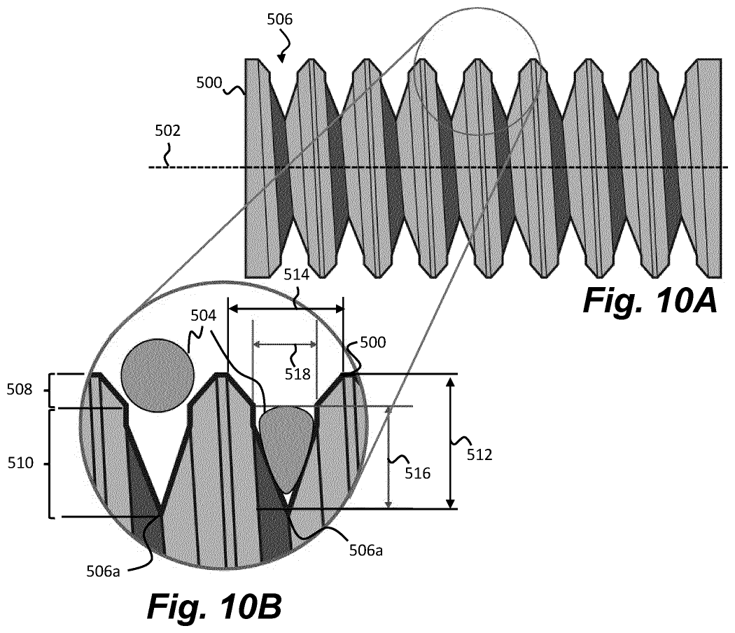

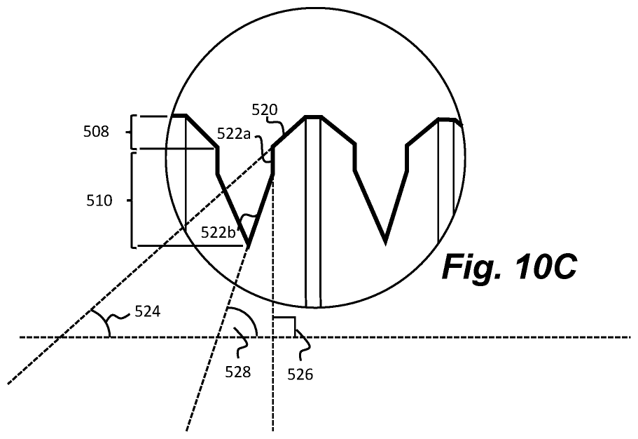

The combined effect of receiving the multi-strand wire 402 in the channel and activating the bondable coating causes the cross-sectional shape of the channel 412 to be imparted to the multi-strand wire 402. For example, the multi-strand wire 402 may have a certain cross-sectional shape before being introduced into the channel 412, and may have a different cross-sectional shape after being removed from the channel 412. The channel 412 therefore provides a means for modifying the cross-sectional shape of the multi-strand wire 402. Various example support members having channels with different predetermined cross-sectional shapes will be described in relation to FIGS. 10-15.

FIG. 10A depicts a side-view of a first example support member 500. FIG. 10B depicts a close-up of a portion of FIG. 10A. The support member 500 defines a longitudinal axis 502 about which a multi-strand wire 504 can be wound. The outer surface of the support member 500 comprises a channel 506 to receive the multi-strand wire 504.

As shown most clearly in FIG. 10B, the channel 506 of this example comprises a tapered mouth portion 508 and a wire receiving portion 510. The tapered mouth portion 508 is arranged towards the outer surface of the support member 500 and the wire receiving portion 510 is arranged radially inward, towards the centre of the support member 500. In some examples, the tapered mouth portion 508 may be omitted.

The tapered mouth portion 508 defines a guide for guiding the multi-strand wire 504 into the wire receiving portion 510 of the channel 506. For example, the inclined surfaces of the tapered mouth portion 508 can “funnel” the multi-strand wire 504 into the channel 506 if it is not accurately aligned with the channel as it is being wound onto the support member 500. The wire receiving portion 510 is the part of the channel 506 which holds or abuts the multi-strand wire 504 once it has been fully received in the channel 506.

In the present example, the wire receiving portion 510 imparts a pre-determined cross-sectional shape to the multi-strand wire 504. FIG. 10B shows the multi-strand wire 504 with a generally circular cross-sectional shape before entering the wire receiving portion 510. As the multi-strand wire 504 is fully received in the wire receiving portion 510, the multi-strand wire 504 may be constricted in one or more dimensions, thereby modifying the cross-section of the multi-strand wire 504.

As shown in FIG. 10B, the channel 506 has a greatest depth dimension 512 measured in direction perpendicular to the longitudinal axis 502, and a greatest width dimension 514 measured in a direction perpendicular to the greatest depth dimension 512. The greatest depth dimension 512 is therefore the overall depth of the channel 506. In this example, the greatest depth dimension 512 is greater than the greatest width dimension 514. Overall, the 506 channel 506 has a width dimension that reduces with distance towards a base 506a of the channel 506. Similarly, the wire receiving portion 510 has a width dimension that reduces with distance towards a base 506a of the channel 506.

As also shown in FIG. 10B, the wire receiving portion 510 has a greatest depth 516 measured in direction perpendicular to the longitudinal axis 502, and a greatest width 518 measured in a direction perpendicular to the greatest depth 516. The greatest depth 516 is therefore the overall depth of the wire receiving portion 510. In this example, the greatest depth 512 is greater than the greatest width 514. Due to this particular shape, the multi-strand wire 504 is constricted/compressed in a dimension parallel to the longitudinal axis 502 and is elongated in a dimension perpendicular to the longitudinal axis 502 as the wire is fully received in the channel 506. Thus, the cross-sectional shape of the wire receiving portion 510 is imparted to the multi-strand wire 504. The multi-strand wire 504 therefore acquires the same cross-sectional shape provided by the channel 506.

The resultant multi-strand wire 504 therefore has a greatest lateral dimension that is greater than a greatest longitudinal dimension. The greatest longitudinal dimension is measured in a direction parallel to the longitudinal axis 502, and the greatest lateral dimension is measured in a direction perpendicular to the greatest longitudinal dimension. The greatest lateral dimension of the multi-strand wire 504 is therefore substantially the same as the greatest depth 516. Similarly, the greatest longitudinal dimension of the multi-strand wire 504 is substantially the same as the greatest width 518.

In a particular example, the multi-strand wire 504 has a diameter of about 1.4 mm before being introduced into the channel 506. The greatest depth 516 is about 1.7 mm and the greatest width 518 is about 1.4 mm. Thus, after being received in the channel 506, the greatest longitudinal dimension of the multi-strand wire 504 remains about 1.4 mm. However, the greatest lateral dimension of the multi-strand wire is increased to about 1.7 mm. The wire strands within the multi-strand wire 504 may therefore become more densely packed in a dimension parallel to the longitudinal axis 502. The wire strands may become less densely packed in a dimension perpendicular to the longitudinal axis 502 as they move.

After the multi-strand wire has been received in the channel, and after the bondable coating has been activated to impart the predetermined cross-sectional shape of the channel to the multi-strand wire, the method further comprises, in block 308, removing the multi-strand wire from the support member. For example, the multi-strand wire may be unwound from the support member. Unwinding the multi-strand wire itself to remove it from the support member may be suitable if the wire has sufficient elasticity, and returns to its coiled shape after unwinding. Alternatively, removing the multi-strand wire from the support member may comprise one of: (i) unscrewing the support member from the coil (i.e. by holding the coil stationary while rotating and withdrawing the support member), or (ii) unscrewing the coil from the support member (i.e. by holding the support member stationary while rotating and withdrawing the coil), or (iii) sliding the coil off the support member or vice versa (if the coil has sufficient elasticity to pass over the raised sections between adjacent troughs of the channel). In at least alternatives (i) and (ii), the channel may have a constant pitch along the length of the support member and/or may extend all the way to one end of the support member, to allow the coil to be more easily separated from the support member.

By setting the shape of multi-strand wire using the bondable coating, the inductor coil substantially retains its shape even after it is removed from the support member. To facilitate removal from the support member, the support member may be formed from or coated with a material to which the multi-strand wire does not adhere strongly, so that the multi-strand wire is not also bonded to the support member during the activation process. The support member may be made of metal, for example.

Once the inductor coil has been formed and removed from the support member, the inductor coil can be assembled in the device 100. The inductor coil may be received on the insulating member 128. For example, the inductor coil can be slid onto the insulating member 128.

FIG. 10C depicts another closeup of a portion of FIG. 10A to more clearly illustrate the tapered mouth portion 508 and the wire receiving portion 510. In this example, a first surface 520 of the tapered mouth portion 508 has a first surface gradient, and a second surface 522a of the wire receiving portion 510 adjacent the tapered mouth portion 508 has a second surface gradient that is greater than the first surface gradient. In other words, the angle of incline 524 of the first surface 520 is smaller than the angle of incline 526 of the second surface 522a. The surface gradients and angle of inclines are defined relative to the longitudinal axis 502. A smaller angle of incline indicates a shallower/smaller gradient. The shallower gradient of the tapered mouth portion 508 provides a smooth transition for the multi-strand wire to be guided in to the channel 506. The second surface 522a (i.e. the surface directly adjacent the tapered mouth portion 508), is vertical in this example. In other examples, the second surface 522a may not be vertical. For example, the surface adjacent the tapered mouth portion 508 may have a gradient like that of the third surface 522b. The third surface 522b has a third surface gradient that is greater than the first surface gradient, and an angle of incline 528 that is greater than the angle of incline 524 of the first surface 520.

FIG. 11 depicts a side-view of a second example support member 550. The support member 550 defines a longitudinal axis 552 about which a multi-strand wire 554 can be wound. The outer surface of the support member 550 comprises a helical channel 556 with a V-shaped cross-section to receive the multi-strand wire 554.

The channel 556 of this example comprises a tapered mouth portion 558 and a wire receiving portion 560 that are continuous. That is, a first surface of the tapered mouth portion 558 has a first surface gradient, and a second surface of the wire receiving portion 560 adjacent the tapered mouth portion 558 has a second surface gradient that is equal to the first surface gradient.

In this example, the wire receiving portion 560 imparts a pre-determined cross-sectional shape to the multi-strand wire 554. FIG. 11 shows the multi-strand wire 554 with a generally circular cross-sectional shape before entering the wire receiving portion 560. As the multi-strand wire 554 is fully received in the wire receiving portion 560, the multi-strand wire 554 may be constricted in one or more dimensions, thereby modifying the cross-section of the multi-strand wire 554.

In this example, as in the example of FIG. 10B, the greatest depth 566 of the wire receiving portion 560 is greater than the greatest width 568 of the wire receiving portion 560. Due to this particular shape, the multi-strand wire 554 is constricted in a dimension parallel to the longitudinal axis 552 and is elongated in a dimension perpendicular to the longitudinal axis 552 as the wire is fully received in the channel 556. Thus, the cross-sectional shape of the wire receiving portion 560 is imparted to the multi-strand wire 554. The multi-strand wire 554 therefore acquires the same cross-sectional shape provided by the channel 556. The multi-strand wire 554 there has a greatest lateral dimension that is greater than a greatest longitudinal dimension.

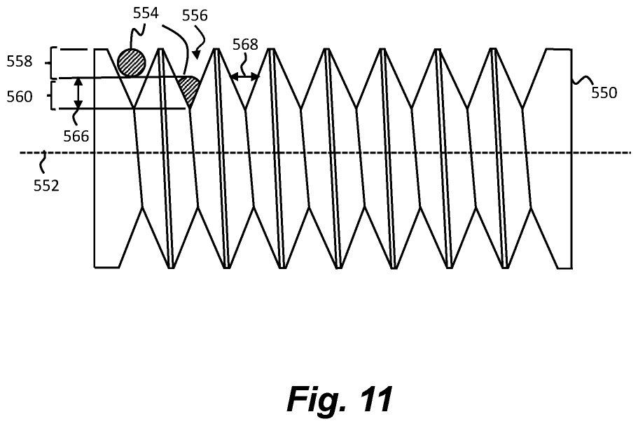

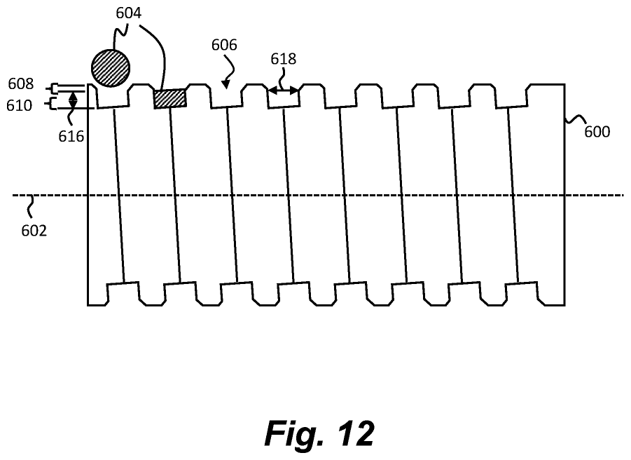

FIG. 12 depicts a side-view of a third example support member 600. The support member 600 of this example differs from that shown in FIGS. 10A-11 in that the channel has a flat floor/base. The deepest section of the channel 606 is therefore flat. The example support member 600 may be used to manufacture an inductor coil in which the multi-strand wire has a shape with at least one flat side, such as rectangular and has a greatest longitudinal dimension that is greater than a greatest lateral dimension.

As in previous examples, the support member 600 defines a longitudinal axis 602 about which a multi-strand wire 604 can be wound. The outer surface of the support member 600 comprises a channel 606 to receive the multi-strand wire 604.

The channel 606 comprises a tapered mouth portion 608 and a wire receiving portion 610. In the present example, the wire receiving portion 610 imparts a pre-determined cross-sectional shape to the multi-strand wire 604. FIG. 12 shows the multi-strand wire 604 with a generally circular cross-sectional shape before entering the wire receiving portion 610. As the multi-strand wire 604 is fully received in the wire receiving portion 610, the multi-strand wire 604 may be constricted in one or more dimensions, thereby modifying the cross-section of the multi-strand wire 604.

In this example, the greatest width 618 of the wire receiving portion 610 is greater than the greatest depth 616 of the wire receiving portion 610. Due to this particular shape, the multi-strand wire 604 is imparted with a cross-sectional shape which has a greatest longitudinal dimension that is greater than a greatest lateral dimension. The multi-strand wire 604 therefore acquires the same cross-sectional shape provided by the channel 606.

FIG. 13 depicts a side-view of a fourth example support member 650. The support member 650 of this example differs from that shown in FIGS. 10A-12 in that the channel does not have a tapered mouth portion, and it has a rounded base. The deepest section of the channel 656 is therefore rounded. As in previous examples, the support member 650 defines a longitudinal axis 652 about which a multi-strand wire 654 can be wound. The outer surface of the support member 650 comprises a generally helical channel 656 with a U-shaped cross-section to receive the multi-strand wire 654.

In the present example, the wire receiving portion 660 imparts a pre-determined cross-sectional shape to the multi-strand wire 664. FIG. 13 shows the multi-strand wire 604 with a generally elliptical cross-sectional shape before entering the wire receiving portion 660. As the multi-strand wire 604 is fully received in the wire receiving portion 660, the multi-strand wire 654 may be constricted in one or more dimensions, thereby modifying the cross-section of the multi-strand wire 654. In other examples, the rounded base of the channel may mean that the multi-strand wire 654 substantially retains its original cross-sectional shape.

As mentioned, the channel 656 does not comprise a tapered mouth portion. That is, the mouth portion 658 of the channel 656 has a width dimension that is generally constant with distance towards the wire receiving portion 660. Instead, it is the wire-receiving portion 660 which has a width dimension that reduces with distance towards a base of the channel 656.

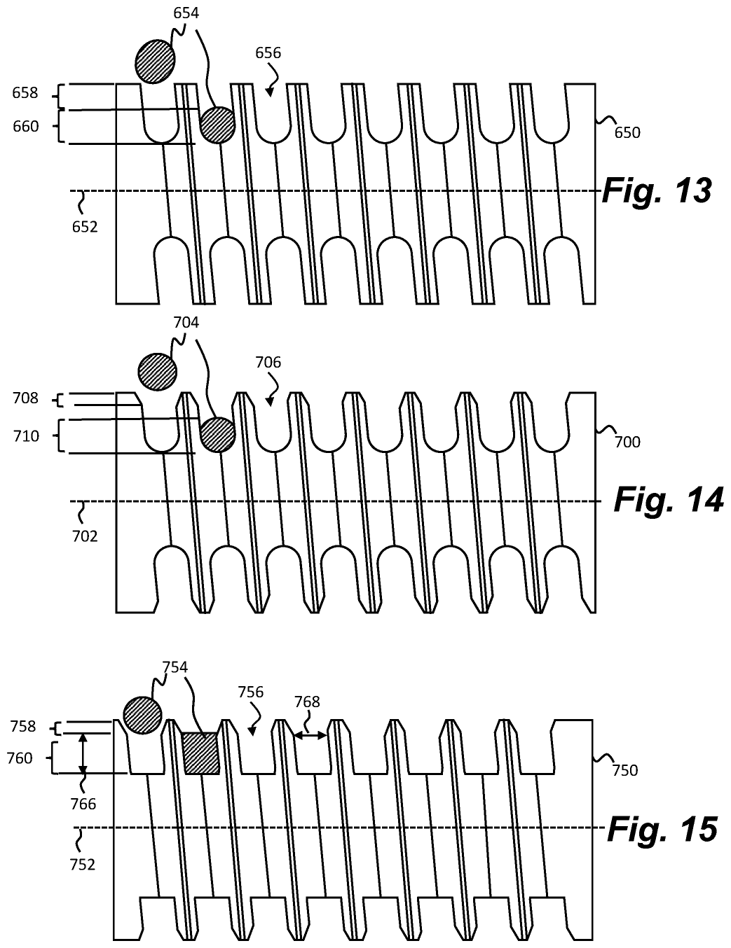

FIG. 14 depicts a side-view of a fifth example support member 700. The support member 700 of this example is similar to that shown in FIG. 13, but instead the channel has a tapered mouth portion 708. As in previous examples, the support member 700 defines a longitudinal axis 702 about which a multi-strand wire 704 can be wound. The outer surface of the support member 700 comprises a generally U-shaped channel 706 to receive the multi-strand wire 704.

In the present example, the wire receiving portion 710 imparts a pre-determined cross-sectional shape to the multi-strand wire 704. FIG. 13 shows the multi-strand wire 704 with a generally circular cross-sectional shape before entering the wire receiving portion 710. As the multi-strand wire 704 is fully received in the wire receiving portion 710, the multi-strand wire 704 may be constricted in one or more dimensions, thereby modifying the cross-section of the multi-strand wire 704. In other examples, the rounded base of the channel may mean that the multi-strand wire 704 substantially retains its original shape.

FIG. 15 depicts a side-view of a sixth example support member 750. The support member 600 of this example has a flat base and has a wire receiving portion 760 that has a greatest depth 766 that is greater than the greatest width 768 of the wire receiving portion. As in previous examples, the support member 750 defines a longitudinal axis 752 about which a multi-strand wire 754 can be wound. The outer surface of the support member 750 comprises a channel 756 to receive the multi-strand wire 754.

The channel 756 comprises a tapered mouth portion 758 and a wire receiving portion 760. In the present example, the wire receiving portion 760 imparts a pre-determined cross-sectional shape to the multi-strand wire 754. FIG. 15 shows the multi-strand wire 754 with a generally circular cross-sectional shape before entering the wire receiving portion 760. As the multi-strand wire 754 is fully received in the wire receiving portion 760, the multi-strand wire 754 may be constricted in one or more dimensions, thereby modifying the cross-section of the multi-strand wire 754.

In this example, the greatest depth 766 of the wire receiving portion 760 is greater than the greatest width 768 of the wire receiving portion 760. Due to this particular shape, the multi-strand wire 754 is imparted with a cross-sectional shape which has a greatest lateral dimension that is greater than a greatest longitudinal dimension. The multi-strand wire 754 therefore acquires the same cross-sectional shape provided by the channel 756. The multi-strand wire 754 may therefore have a generally rectangular shape.

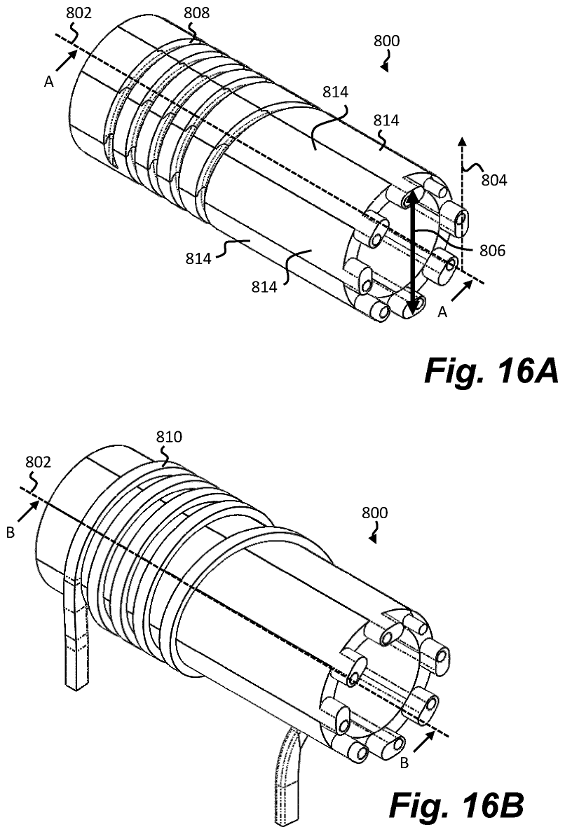

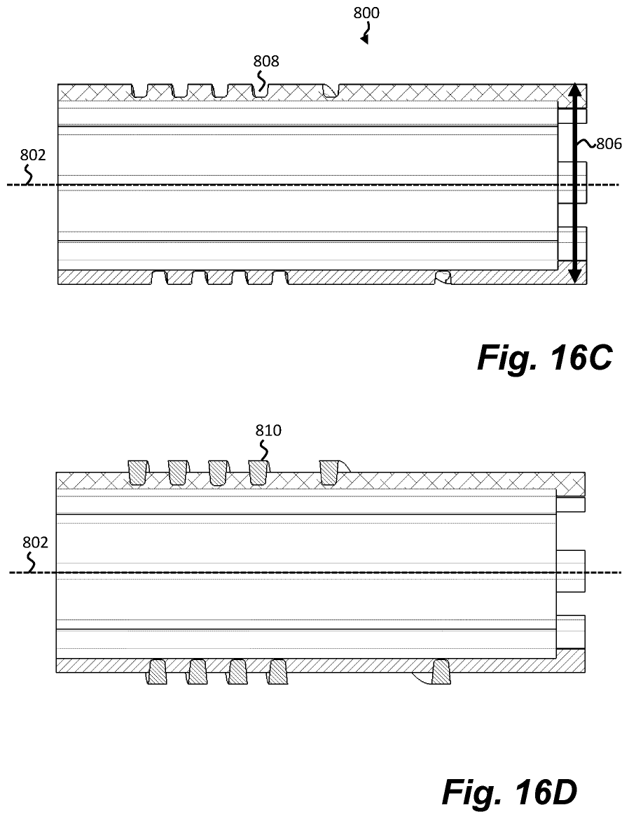

The support member in the above-described examples has a fixed cross-sectional width perpendicular to the axis defined by the support member. In other examples, the cross-sectional width of the support member may be variable. An example support member having a variable cross-sectional width will be described in relation to FIGS. 16A-20. It should be noted that the support member(s) described in the above examples may also have a variable cross-sectional width in combination with the features described in those examples. Similarly, the support member(s) described in FIGS. 16A-20 may also have any of the features described in the above examples.

FIG. 16A depicts an example support member 800 that can be moved between two or more configurations. In FIG. 16A, the support member 800 defines a first axis 802, such as a longitudinal axis. A second axis 804 is arranged perpendicular to the first axis 802. In FIG. 16A, the support member 800 is arranged in a first configuration in which the support member 800 has a first cross-sectional width 806. While the support member may take any shape, the support member 800 in this example has a cylindrical shape and a diameter equal to the first cross-sectional width 806.

An outer surface of the support member 800 has a channel 808, such as a helical channel, that extends around the first axis 802 along a length of the support member 800. As described above, a wire can be wound around the support member 800 and be received within the channel 808. In other examples, the channel may be omitted, and the wire may be wound directly onto the outer surface of the support member 800. In either case, the support member 800 is arranged in the first configuration while the inductor coil is being formed. FIG. 16B shows a wire 810 wound around the support member 800 to form an inductor coil.

FIG. 16C shows a cross-sectional view of the support member of FIG. 16A viewed along the direction “A”. FIG. 16D shows a cross-sectional view of the support member of FIG. 16B viewed along the direction “B”.

In these examples, the channel 808 has a variable pitch along the length of the support member 800. In other words, the spacing between adjacent turns may vary along the length of the support member 800. In other examples however, the channel 808 may have a constant pitch.

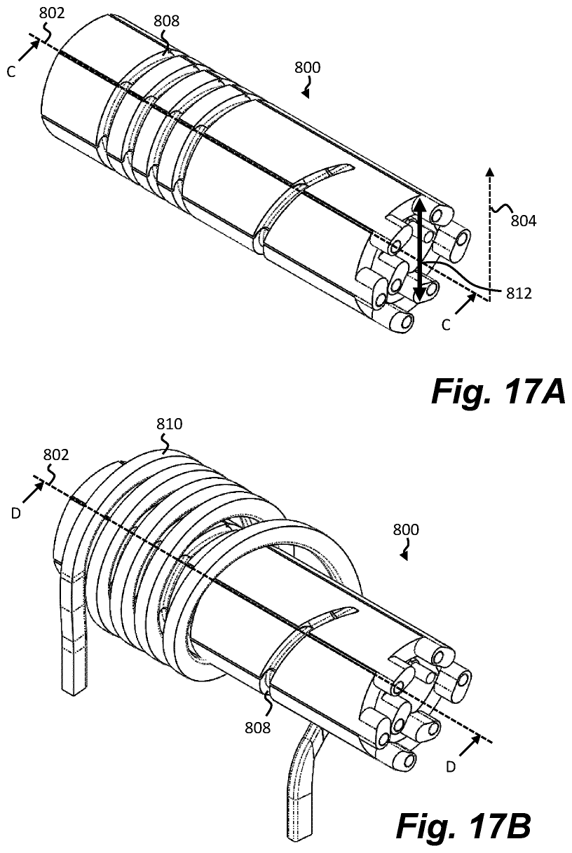

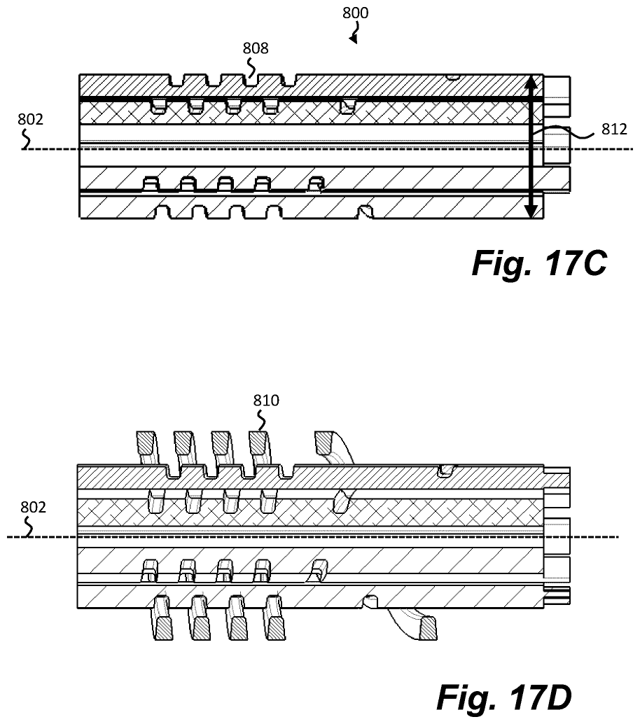

FIG. 17A depicts the support member 800 arranged in a second configuration, after the cross-sectional width of the support member 800 has been reduced. In FIG. 17A, the support member 800 has a second cross-sectional width 812 that is smaller than the first cross-sectional width 806. This can be achieved via many different mechanisms, but in this example, the support member has been collapsed by rolling the support member 800 into a spiral configuration. FIG. 17A shows the support member 800 without the wire 810, whereas FIG. 17B shows the wire 810 after it has been formed into an inductor coil. In contrast to FIG. 16B, FIG. 17B shows that as the cross-sectional width of the support member 800 is reduced, the wire 810 (and therefore the inductor coil) is loosened and can be easily removed from the support member 800. The inductor coil can be moved along the length of the support member 800 and removed from the support member 800 entirely. By reducing the cross-sectional width of the support member 800 after the inductor coil has been formed, removal of the inductor coil is less likely to damage or deform the final shape of the coil.

FIG. 17C shows a cross-sectional view of the support member of FIG. 17A viewed along the direction “C”. FIG. 17D shows a cross-sectional view of the support member of FIG. 17B viewed along the direction “D”.

Returning to FIG. 16A, the support member 800 is shown formed from a plurality of segments 814 arranged circumferentially around the first axis 802. That is, each segment extends partially around the outer circumference/perimeter of the support member 800. Each segment 814 extends along the length of the support member 800 in a direction parallel to the first axis 802. The segments 814 are relatively movable to allow the support member 800 to be moved between the first and second configurations.

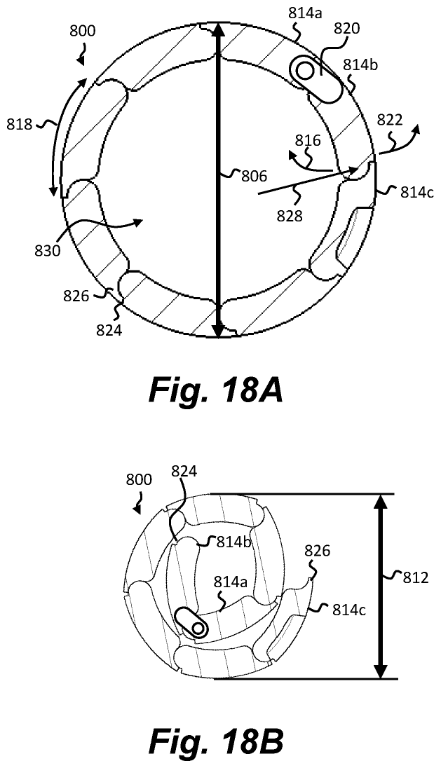

FIG. 18A shows an end view the support member 800 of FIG. 16A when viewed along the first axis 802. Thus, in FIG. 18A, the support member 800 is arranged in the first configuration. FIG. 18B shows an end view the support member 800 of FIG. 17A when viewed along the first axis 802. Thus, in FIG. 18B, the support member 800 is arranged in the second configuration. In both FIGS. 18A and 18B, the first axis 802 extends into the page.

The support member 800 has eight segments in this example but may have more or fewer segments in other examples. Three segments 814a, 814b, 814c are labelled for reference. Each segment has an arc length 818 that extends at least partially around the outer circumference of the support member 800. The segments are therefore arranged circumferentially around the first axis 802.

With reference to FIG. 18A, a first segment 814a is arranged adjacent a second segment 814b, and the first segment 814a is configured to move relative to the second segment 814b as the support member 800 moves between the first and second configurations. For example, the second segment 814b may rotate or pivot relative to the first segment 814a, in the direction 816. FIG. 18B shows the second segment 814b after it has rotated towards the first segment 814a. To enable this rotation, the adjacent segments 814a, 814b may be connected via a hinge 820. It should be noted that only one hinge is depicted in FIGS. 18A and 18B for simplicity. Several other segments may also be connected via hinges. Moreover, each pair of the adjacent segments may be connected by a plurality of hinges.

A third segment 814c is arranged adjacent the second segment 814b, and the third segment 814c is configured to move relative to the second segment 814b as the support member 800 moves between the first and second configurations. In this example, the second segment 814b is not permanently connected to the adjacent third segment 814c. Instead, the two segments 814b, 814c may abut when in the first configuration, and be moved apart as the support member moves towards the second configuration (as shown in FIG. 18B). The second segment 814b may thus form one end of the support member's circumference, and the third segment 814c may form an opposite end of the circumference. By moving these two segments 814b, 814c relative to each other, the support member 800 can be moved between the first and second configurations. In the second configuration, the support member 800 may be said to be arranged in a spiral/rolled configuration because the outer edge of the support member spirals inwards as the segments are moved.

In some examples, it may be advantageous to stop the segments from pivoting in the opposite direction to that intended. For example, it may be useful to only permit rotation in the direction of arrow 816, and restrict rotation in the direction of arrow 822 shown in FIG. 18A. To limit this movement, each segment may comprise a stop for limiting movement of the segment relative to an adjacent segment. The stop therefore limits the extent to which the support member 800 is movable away from the second configuration (i.e. it cannot move beyond the first configuration). To provide the stop, each segment may comprise a receiving portion 824 to interlock with a protruding portion 826 on an adjacent segment. This interlocking of components, in addition to the support provided by the hinge, stops the adjacent segments from moving in the opposite direction. The receiving portion may be in the form of a recess or cut-away portion, and the protruding portion may be in the form of a lip or extremity that docks with the receiving portion. Other forms of stop may be employed in other examples.

In this particular example, the support member 800 is biased towards the second configuration. That is, without the application of an external force, the support member 800 will occupy the second configuration. In one example, this is achieved by providing biased hinges 820 between adjacent segments. For example, one or more hinges may comprise a spring or other biasing mechanism to cause adjacent segments to rotate towards each other. For example, the biased hinge 820 may cause the second segment 814b to rotate in the direction of arrow 816. In other examples, the spring or other biasing mechanism may be separate to the hinge. Some, or all, of the hinges may be biased.

To hold the support member 800 in the first configuration, an external force may be applied. For example, a device (not shown) may apply a force to the inner surface of the support member 800 at one or more locations. The device may be inserted into the hollow cavity 830 of the support member 800. Arrow 828 in FIG. 18A shows the application of a force to the inner surface of the second segment 814b to hold the segment in abutment with the third segment 814c. Due to the biased nature of the hinge 820, removal of the device (and therefore the force) causes the second segment 814b to rotate in the direction of arrow 816, and the support member moves towards the second configuration of FIG. 18B.

In a particular example, the device is moveable along the first axis 802 to cause movement of the support member 800 between the first and second configurations. For example, when the support member 800 is in the first configuration, the device may located at a first position along the axis 802 within a hollow cavity 830 of the support member to hold the support member 800 in the first configuration, and when the support member 800 is in the second configuration, the device is located at a second position along the axis 802 different to the first position.

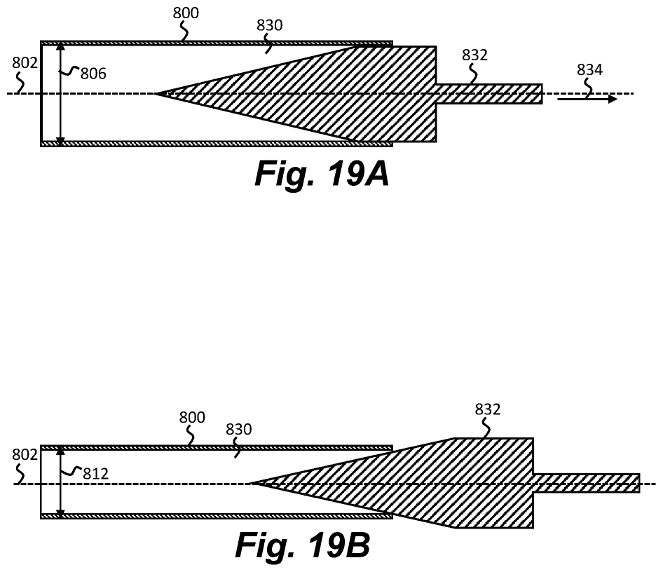

FIG. 19A depicts a cross-sectional side view of an example support member 800 and a device 832 inserted into the hollow cavity 830 of the support member 800. Here, the device 832 is located at a first position along the first axis 802. In FIG. 19A, the support member 800 is arranged in the first configuration and the device 830 is abutting an inner surface of the support member 800 to hold the support member 800 in the first configuration.

FIG. 19B depicts the support member 800 at a later time, after the device 832 has been moved along the first axis 802 in a direction indicated by arrow 834. The device 832 has been at least partially withdrawn from the hollow cavity 830 of the support member 800, and is now located at a second position along the first axis 802. In some examples the device 832 may be fully removed from the hollow cavity.

As shown, the device 832 has a tapered profile so that as the device 832 is moved in direction 834, the wider portion of the device 832 is removed from the cavity, thus causing the cross-sectional width of the support member 800 to decrease until the support member 800 is in the second configuration. The support member 800 reconfigures because of the biased nature of the support member 800.

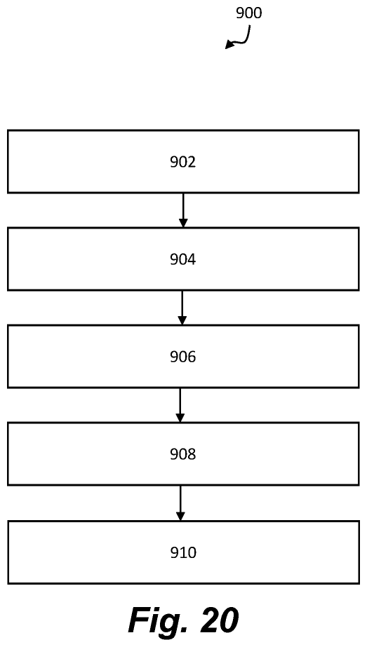

FIG. 20 depicts a flow diagram of a method 900 for forming an aerosol provision device inductor coil.

The method comprises, in block 902, providing a multi-strand wire 810 comprising a plurality of wire strands, wherein at least one of the plurality of wire strands comprises a bondable coating. As mentioned above, a bondable coating is a coating which surrounds the wire strand, and can be activated (such as via heating), so that the strands within the multi-strand wire bond to one more neighbouring strands. The bondable coating allows the multi-strand wire to be formed into the shape of an inductor coil on a support member, and after the bondable coating is activated, the multi-strand wire will retain its shape. The bondable coating therefore “sets” the shape of the inductor coil.

The method further comprises, in block 904, winding the multi-strand wire around a support member 800 defining an axis 802. For example, the multi-strand wire may be wound around the support member 800 in a helical fashion.

As the multi-strand wire 810 is being wound around the support member 800, the method 900 further comprises, in block 906, activating the bondable coating such that the multi-strand wire substantially retains a shape determined by the support member 800 (such as that provided by the channel 808). Alternatively, block 906 may occur after the multi-strand wire 810 has been fully wound around the support member 800.

After the multi-strand wire has been wound, and after the bondable coating has been activated, the method further comprises, in block 908, reducing a cross-sectional width of the support member in a direction perpendicular to the axis. Reducing the cross-sectional width of the support member may comprise causing the support member to move between a first configuration and a second configuration, wherein, when the support member is in the second configuration, the cross sectional width of the support member perpendicular to the axis is smaller than when the support member is in the first configuration.

After the cross-sectional width of the support member has been reduced, the method further comprises, in block 910, removing the multi-strand wire from the support member.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of forming an inductor coil for an aerosol provision device, the method comprising:
providing a multi-strand wire comprising a plurality of wire strands, wherein at least one of the plurality of wire strands comprises a bondable coating;
winding the multi-strand wire around a support member such that the multi-strand wire is received in a channel formed in an outer surface of the support member;
activating the bondable coating such that the multi-strand wire substantially retains a shape determined by the channel; and
removing the multi-strand wire from the support member.

2. A method according to claim 1, wherein the winding and the activating comprises changing a cross-sectional shape of at least part of the multi-strand wire.

3. A method according to claim 2, wherein the channel has a predetermined cross-sectional shape, and the changing the cross-sectional shape comprises imparting at least part of the predetermined cross-sectional shape to the at least part of the multi-strand wire.

4. A method according to claim 2 or claim 3, wherein:
the support member defines an axis, and wherein the winding comprises winding the multi-strand wire around the axis; and
the changing the cross-sectional shape comprises:
modifying a cross-section of the multi-strand wire such that the cross-section of the multi-strand wire has a greatest longitudinal dimension that is different to a greatest lateral dimension, wherein the greatest longitudinal dimension is measured in a direction parallel to the axis, and the greatest lateral dimension is measured in a direction perpendicular to the greatest longitudinal dimension.

5. A method according to claim 4, wherein:
the greatest longitudinal dimension is greater than the greatest lateral dimension; or
the greatest longitudinal dimension is smaller than the greatest lateral dimension.

6. A method according to claim 5, wherein the modifying the cross-sectional shape of the multi-strand wire comprises compressing the multi-strand wire in a direction parallel to the axis so as to increase a density of the plurality of wire strands.

7. A method according to any preceding claim, wherein the activating the bondable coating comprises heating the support member such that the bondable coating is heated.

8. A method according to claim 7, wherein the heating is performed at the same time as the winding.

9. A method according to claim 7 or 8, wherein the heating the support member comprises heating the support member to a temperature of between about 150° C. and 350° C.

10. A method according to any preceding claim, comprising rotating the support member about an axis of the support member, thereby causing the winding of the multi-strand wire around the support member.

11. A support member for use in forming an inductor coil of an aerosol provision device, the support member defining an axis about which a multi-strand wire of the inductor coil is windable, wherein an outer surface of the support member comprises a channel to receive the multi-strand wire.

12. A support member according to claim 11, wherein:
the channel has a greatest depth dimension measured in direction perpendicular to the axis and a greatest width dimension measured in a direction perpendicular to the greatest depth dimension; and
the greatest depth dimension is different to the greatest width dimension.

13. A support member according to claim 11 or 12, wherein:
the channel comprises a tapered mouth portion leading to a wire receiving portion configured to receive the multi-strand wire;
the wire receiving portion has a greatest depth measured in direction perpendicular to the axis and a greatest width measured in a direction perpendicular to the greatest depth; and
the greatest depth is different to the greatest width.

14. A support member according to claim 13, wherein a ratio of the greatest depth to the greatest width is between about 1.1:1 and 2:1.

15. A support member according to claim 13 or 14, wherein the greatest width is between about 1.2 mm and about 1.5 mm.

16. A support member according to any of claims 13 to 15, wherein the channel is a helical channel.

17. A support member according to any of claims 11 to 16, wherein a floor of the channel is substantially flat or rounded.

18. A support member according to any of claims 11 to 17, wherein the channel has a width dimension that reduces with distance towards a floor of the channel.

19. An aerosol provision device inductor coil manufacturing system, comprising:
a support member according to any of claims 11 to 18; and
a drive assembly configured to rotate the support member about an axis of the support member, such that, in use, the multi-strand wire is wound on to the support member.

20. A system according to claim 19, further comprising
a wire feeding assembly for feeding the multi-strand wire on to the support member.

21. A system according to claim 20, wherein the drive assembly is further configured to move the support member relative to the wire feeding assembly in a direction parallel to the axis.

22. A system according to any of claims 19 to 21, further comprising a heater for heating the support member.

23. A system according to any of claims 19 to 22, further comprising an anchor configured to hold a portion of the multi-strand wire relative to the support member as the multi-strand wire is wound on to the support member.

24. An inductor coil for an aerosol provision device, the inductor coil formed according to a method comprising the method of any one of claims 1 to 10.

25. An inductor coil for an aerosol provision device, wherein the inductor coil defines an axis and comprises a multi-strand wire that is wound around the axis, and wherein the multi-strand wire has a cross section with a greatest lateral dimension that is greater than a greatest longitudinal dimension, wherein the greatest lateral dimension is measured in a direction perpendicular to the axis, and the greatest longitudinal dimension is measured in a direction perpendicular to the greatest lateral dimension.

26. A support member for use in forming an inductor coil of an aerosol provision device, the support member defining an axis about which a wire of the inductor coil is windable, wherein the support member is moveable between a first configuration, in which the wire is windable around the support member, and a second configuration, in which a cross sectional width of the support member perpendicular to the axis is smaller than when the support member is in the first configuration thereby to facilitate removal of the wire from the support member.

27. A support member according to claim 26, wherein an outer surface of the support member comprises a channel to receive the wire.

28. A support member according to claim 26 or 27, wherein the support member is biased towards the second configuration.

29. A support member according to any one of claims 26 to 28, wherein an outer surface of the support member is formed by a plurality of segments arranged circumferentially around the axis.

30. A support member according to claim 29, wherein at least one segment of the plurality of segments is configured to move relative to an adjacent segment of the plurality of segments, as the support member moves between the first and second configurations.

31. A support member according to claim 30, wherein at least one segment of the plurality of segments is connected to an adjacent segment of the plurality of segments via a hinge.

32. A support member according to claim 30 or 31, wherein at least one segment of the plurality of segments is not permanently connected to an adjacent segment of the plurality of segments.

33. A support member according to any one of claims 30 to 32, wherein at least one segment of the plurality of segments has a stop for limiting movement of the at least one segment relative to an adjacent segment thereby to limit the extent to which the support member is movable away from the second configuration.

34. A support member according to any one of claims 26 to 33, wherein, in the second configuration, the support member is in a spiral configuration.

35. A support member according to any one of claims 26 to 34, wherein, when in the first configuration, the support member defines a hollow cavity to receive a device to hold the support member in the first configuration.

36. A system comprising:
a support member according to any one of claims 26 to 35; and
a device configured to cause movement of the support member between the first and second configurations.

37. A system according to claim 36, wherein the device is moveable along the axis to cause movement of the support member between the first and second configurations.

38. A system according to claim 37, configured so that:
when the support member is in the first configuration, the device is located at a first position along the axis within a hollow cavity of the support member to hold the support member in the first configuration; and
when the support member is in the second configuration, the device is located at a second position along the axis different to the first position.

39. A system according to any one of claims 36 to 38, further comprising a biasing mechanism for biasing the support member towards the second configuration.

40. A method of forming an inductor coil for an aerosol provision device, the method comprising:
providing a multi-strand wire comprising a plurality of wire strands, wherein at least one of the plurality of wire strands comprises a bondable coating;
winding the multi-strand wire around a support member defining an axis;
activating the bondable coating such that the multi-strand wire substantially retains a shape determined by the support member;
reducing a cross-sectional width of the support member in a direction perpendicular to the axis; and
removing the multi-strand wire from the support member.

41. A method according to claim 40, wherein the reducing the cross-sectional width of the support member comprises:
causing the support member to move between a first configuration and a second configuration, wherein, when the support member is in the second configuration, the cross-sectional width of the support member perpendicular to the axis is smaller than when the support member is in the first configuration.

42. A method according to claim 41, wherein:
when the support member is in the first configuration, a device is located at a first position along the axis within a hollow cavity of the support member to hold the support member in the first configuration;
when the support member is in the second configuration, the device is located at a second position along the axis different to the first position; and
the causing the support member to move between a first configuration and a second configuration comprises moving the device between the first position and the second position.

43. A method according to any one of claims 40 to 42, wherein an outer surface of the support member is formed by a plurality of segments arranged circumferentially around the axis, and wherein the reducing the cross-sectional width of the support member comprises moving at least one segment of the plurality of segments relative to an adjacent segment of the plurality of segments.

44. A method according to any of claims 40 to 43, wherein:
the winding comprises winding the multi-strand wire around the axis; and
the removing the multi-strand wire from the support member comprises moving the multi-strand wire relative to the support member in a direction parallel to the axis.

45. A method according to any of claims 40 to 44, wherein the winding the multi-strand wire around the support member comprises receiving the multi-strand wire in a channel formed in an outer surface of the support member;

46. A method according to claim 45, wherein the winding and the activating comprises changing a cross-sectional shape of at least part of the multi-strand wire.

47. An inductor coil for an aerosol provision device, the inductor coil formed according to a method comprising the method of any one of claims 40 to 46.
